(19) United States
(12) Patent Application Publication
(10) Pub. No.: US 2011/0308683 A1
(43) Pub. Date: Dec. 22, 2011

(54) RIM MOUNTED TIRE AND MEASUREMENT DEVICE ASSEMBLY

(76) Inventor: Richard Nicholas Crano, Akron, OH (US)

(21) Appl. No.: 12/816,607

(22) Filed: Jun. 16, 2010

(51) Int. Cl. B60C 23/06; B60C 5/00

(52) U.S. Cl. 152/450

(57) ABSTRACT

A tire, rim, and rim-mounted measurement device assembly includes a rim having a measurement device circumferential mounting surface; a tire mounted over the rim and having an inner liner region located radially inward from a crown region of the tire; one or more pairs of measurement devices mounted to the rim circumferential surface. Each measurement device has an operatively extending and retracting component attached to a respective attachment position on the inner liner region, and each of the measurement devices cooperatively measuring a designated type of deformation of the tire crown region within a rolling tire footprint.

### FIELD OF THE INVENTION

The invention relates generally to a rim mounted tire and measurement apparatus assembly and, more specifically, to such an assembly for measuring crown displacement in the tire.

### BACKGROUND OF THE INVENTION

It is desirable to understand the dynamics of a rolling tire subjected to radial, axial and longitudinal forces and to achieve an apparatus that can be used to quantify displacement within a rolling tire subject to such forces.

### SUMMARY OF THE INVENTION

According to an aspect of the invention, a tire, rim, and rim-mounted measurement device assembly is provided including a rim having a measurement device circumferential mounting surface; a tire mounted over the rim and having an inner liner region radially inward from a crown region of the tire; one or more pairs of measurement devices mounted to the rim circumferential surface, each measurement device having an operatively extending and retracting component attaching to a respective attachment position on the inner liner region. Each measurement device operatively measures a specified type of displacement of its respective attachment position responsive to deformation of the tire crown region within a rolling tire footprint.

In another aspect, the first pair of the measurement devices include spaced apart string potentiometer devices mounted to the rim circumferential surface to operatively measure radial and fore-aft displacement of the respective attachment position of each string potentiometer to the inner liner region responsive to deformation of the tire crown region within a rolling tire footprint. A pair of idler pulleys may be deployed adjacent respective string potentiometer devices on the rim circumferential surface, with a single cable routed between the potentiometers by way of the respective idler pulleys. The respective attachment positions of the first pair of string potentiometer devices to the tire inner liner region are, according to a further aspect of the invention, coincidental.

In yet another aspect of the invention, a second pair of measurement devices are mounted an opposite side of the rim circumferential surface, each second pair measurement device having an operatively extending and retracting component attaching to a respective attachment position on the inner liner region, and each of the second pair of measurement devices operatively measuring a radial and side-to-side displacement of the respective attachment position responsive to deformation of the tire crown region within a rolling tire footprint.

With respect to still a further aspect of the invention, the respective attachment positions of each pair of string potentiometers to the inner liner region are coincidental.

### DEFINITIONS

“Aspect ratio” of the tire means the ratio of its section height (SH) to its section width (SW) multiplied by 100 percent for expression as a percentage.

“Asymmetric tread” means a tread that has a tread pattern not symmetrical about the center plane or equatorial plane EP of the tire.

“Axial” and “axially” means lines or directions that are parallel to the axis of rotation of the tire.

“Camber angle” means the angular tilt of the front wheels of a vehicle. Outwards at the top from perpendicular is positive camber; inwards at the top is negative camber.

“Circumferential” means lines or directions extending along the perimeter of the surface of the annular tread perpendicular to the axial direction.

“Equatorial Centerplane (CP)” means the plane perpendicular to the tire's axis of rotation and passing through the center of the tread.

“Footprint” means the contact patch or area of contact of the tire tread with a flat surface at zero speed and under normal load and pressure.

“Groove” means an elongated void area in a tread that may extend circumferentially or laterally about the tread in a straight, curved, or zigzag manner. Circumferentially and laterally extending grooves sometimes have common portions. The “groove width” is equal to tread surface area occupied by a groove or groove portion, the width of which is in question, divided by the length of such groove or groove portion; thus, the groove width is its average width over its length. Grooves may be of varying depths in a tire. The depth of a groove may vary around the circumference of the tread, or the depth of one groove may be constant but vary from the depth of another groove in the tire. If such narrow or wide grooves are substantially reduced depth as compared to wide circumferential grooves which the interconnect, they are regarded as forming “tie bars” tending to maintain a rib-like character in tread region involved.

“Inboard side” means the side of the tire nearest the vehicle when the tire is mounted on a wheel and the wheel is mounted on the vehicle.

“Lateral” means an axial direction.

“Lateral edges” means a line tangent to the axially outermost tread contact patch or footprint as measured under normal load and tire inflation, the lines being parallel to the equatorial centerplane.

“Net contact area” means the total area of ground contacting tread elements between the lateral edges around the entire circumference of the tread divided by the gross area of the entire tread between the lateral edges.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Outboard side” means the side of the tire farthest away from the vehicle when the tire is mounted on a wheel and the wheel is mounted on the vehicle.

“Radial” and “radially” means directions radially toward or away from the axis of rotation of the tire.

“Rib” means a circumferentially extending strip of rubber on the tread which is defined by at least one circumferential groove and either a second such groove or a lateral edge, the strip being laterally undivided by full-depth grooves.

“Sipe” means small slots molded into the tread elements of the tire that subdivide the tread surface and improve traction, sipes are generally narrow in width and close in the tires footprint as opposed to grooves that remain open in the tire's footprint.

“Slip angle” means the angle of deviation between the plane of rotation and the direction of travel of a tire.

“Tread element” or “traction element” means a rib or a block element defined by having a shape adjacent grooves.

“Tread Arc Width” means the arc length of the tread as measured between the lateral edges of the tread.

### BRIEF DESCRIPTION OF THE DRAWINGS

The invention will be described by way of example and with reference to the accompanying drawings in which:

FIG. 1 is a perspective view in partial section of a tire, rim and measurement device assembly;

FIG. 2A is an enlarged perspective view of a mounting fixture for securing ends of a pair of string potentiometer measurement devices to a coincident tire inner liner region location;

FIG. 2B is an enlarged perspective view of a string potentiometer suitable for mounting to a rim;

FIG. 3A is a transverse section view through an unloaded rim-mounted tire having a pair of measurement devices mounted to the rim pursuant to the invention;

FIG. 3B is a transverse section view through the assembly of FIG. 3A shown in the loaded (moving tire) condition showing radial displacement of the string potentiometer pair attachment point.

FIG. 3C is a transverse section view through the assembly of FIG. 3A shown in the loaded condition and showing lateral side-to side displacement of the string potentiometer pair attachment point.

FIG. 4 is an alternative embodiment of the invention showing the deployment of two pairs of rim-mounted measurement devices, each pair assigned to measure a designated type of attachment point displacement within the footprint of a moving tire;

FIG. 5 is a perspective view of a rim mounted tire shown in partial section and illustrating a placement of four string potentiometers on the rim mounting surface;

FIG. 6 is an alternative embodiment of the assembly showing the deployment of a pair of idler pulleys disposed adjacent to respective string potentiometers.

### DETAILED DESCRIPTION OF THE INVENTION

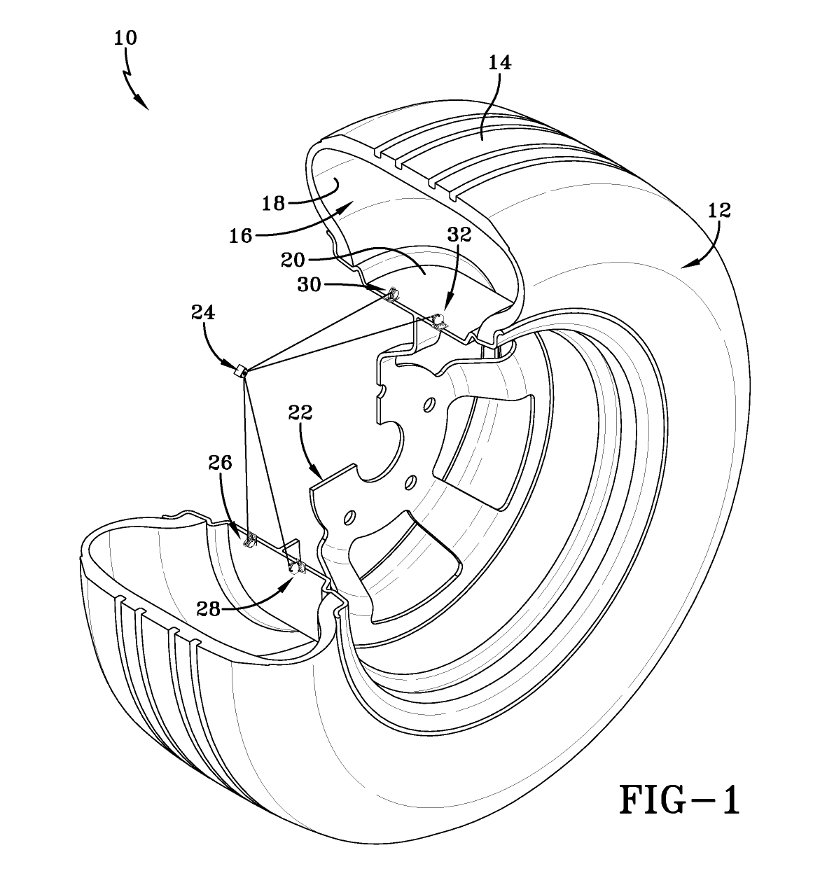

Referring initially to FIGS. 1, 2A, 2B, 3A-C, and 4, a rim mounted tire assembly 10 includes a tire 12 of conventional type and construction, such as a radial tire for passenger or commercial usage. The tire 12 has a tread crown region 14, and an internal cavity defined by a tire inner liner 18. An inner liner crown region 18A underlies the tread crown region 14. The tire 12 mounts in conventional fashion to a rim 22 such that a circumferential rim surface 20 faces into the tire cavity 16.

One or more anchoring fixtures 24 are mounted to the inner liner crown region 18A preferably although not necessarily on the equatorial center line of the tire. An anchoring fixture 24 is used to secure a string line from one or more string potentiometers 26, 28, 30, 32. The anchoring fixture 24 includes an attachment plate 34 from which a right angled mounting plate 40 depends. An adhesive 36 coats an outward surface of the attachment plate 38, covered by a protective sheet 38. The anchoring fixture 24 can thereby be secured to any desired position on the inner liner crown region 18A by adhesive attachment or other suitable means.

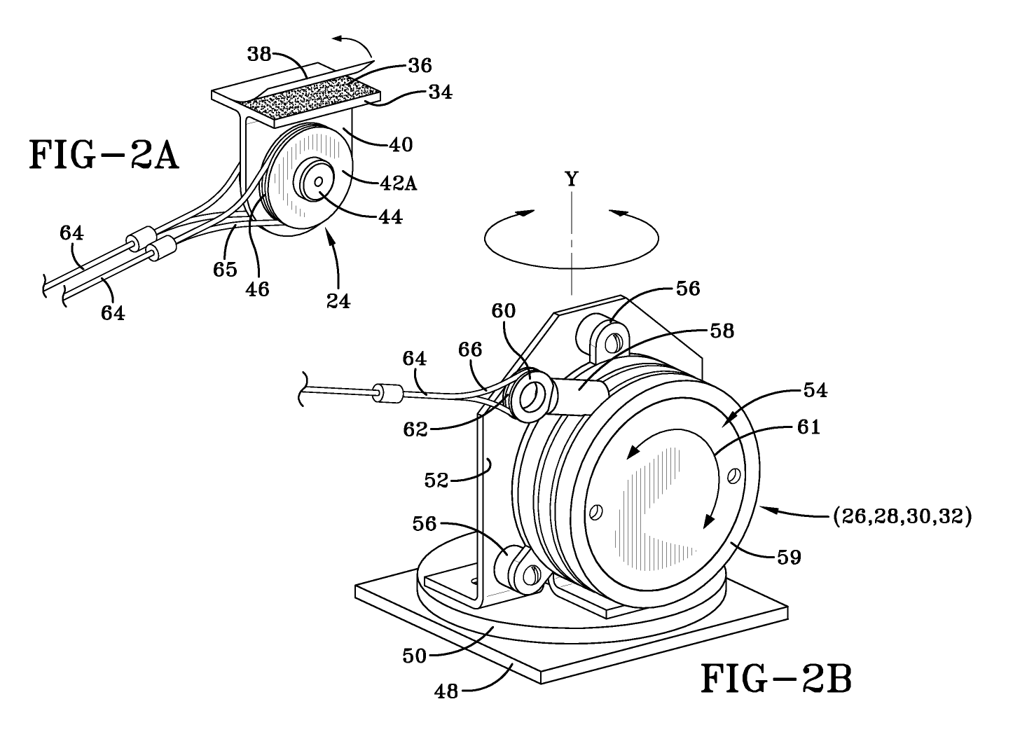

A pair of rotating pulleys 42A and 42B mount to opposite sides of the vertical mounting plate 40 by means of axial pin 44, each having a circumferential line-receiving channel 46. The location of the anchoring fixture 24 on the inner liner crown region 18A is referred to herein as the “attachment position” for the string potentiometer(s) deployed as described and shown in FIG. 2B. While pulleys are shown, other means for anchoring the string potentiometers may be deployed such as, but not limited to, gimbals that attach to the innerliner.

The string potentiometer(s) 26, 28, 30, 32 deployed within the rim mounted tire assembly 10 are of a type commercially available. More or fewer potentiometers may be used without departing from the teachings of the invention. A potentiometer of the type shown is commercially sold as a MTA transducer by Celesco Transducer Products, Inc. located at 20630 Plummer Street, Chatsworth, Calif. 91311. The transducer uses a high-cycle conductive plastic potentiometer to provide a voltage divider feedback signal for measurement ranges of 3 or 5 inches full stroke.

As shown in detail in FIG. 2B, the string potentiometer assembly includes a mounting plate 48 to which a swivel mounted base plate 50 attaches. A mounting bracket 52 mounts to the base plate 50 and the potentiometer measurement device 26 attaches to the upright bracket 52 by suitable attachment hardware such as pins 56. The potentiometer is thus free to rotate 360 degrees about axis Y. The potentiometer measurement device(s) 26, 28, 30, and 32 include a cable or string line 64 formed from a suitable material such as nylon coated stainless steel. A terminal end loop 66 of the cable 64 attaches to an eyelet 60 of a rotary actuator arm 58 of the potentiometer and resides within an eyelet channel 62. The actuator arm 58 rotates within a potentiometer housing 59 as illustrated by the arrow 61 as the cable 64 extends and retracts within the aforementioned stroke limit. The potentiometer provides a feedback signal for measuring the extension and retraction of the cable 64.

It will be appreciated from FIG. 2A that an opposite end loop 65 of the cable 64 attaches to a rotary pulley 43A or B of the anchoring fixture 24. As the distance between the fixture 24 and the potentiometer assembly 26, 28, 30, 32 changes, such change will cause a rotational movement of the actuator arm 58 as the cable 64 extends and retracts. The feedback signal detected by the potentiometer from the rotational movement of arm 58 can thus be electronically processed and used to calculate the distance between fixture 24 and assembly 26, 28, 30 or 32.

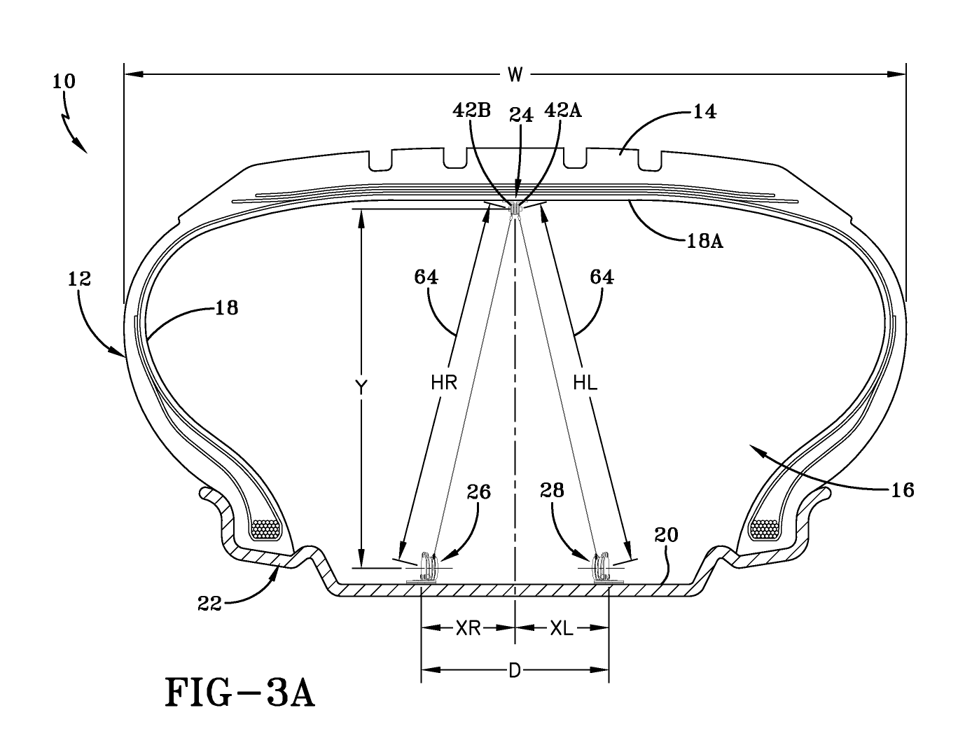

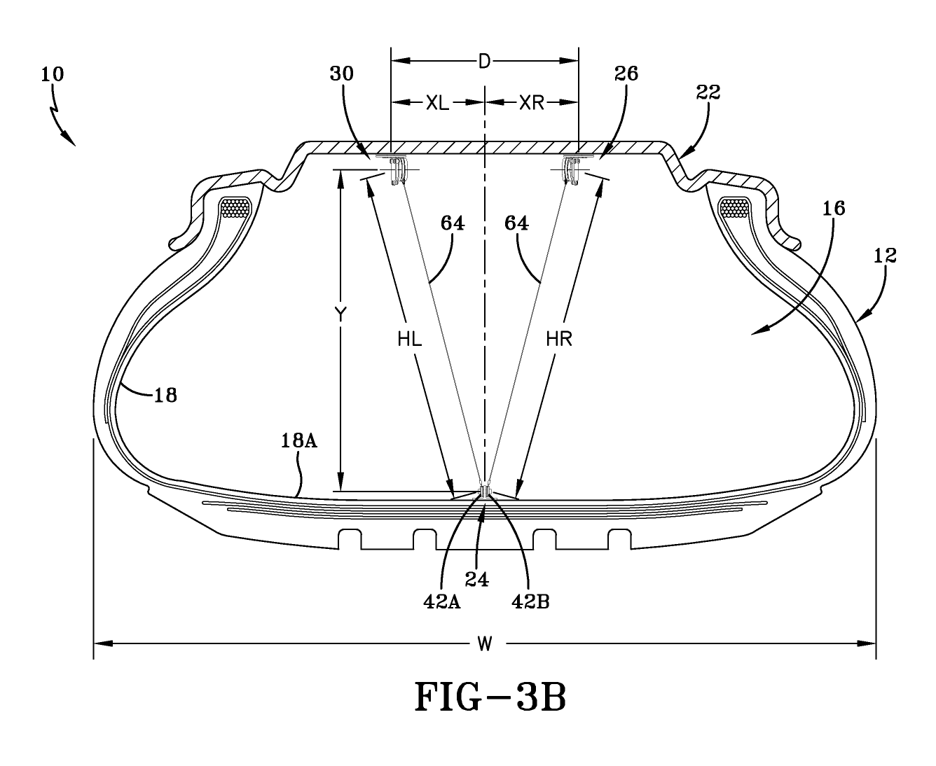

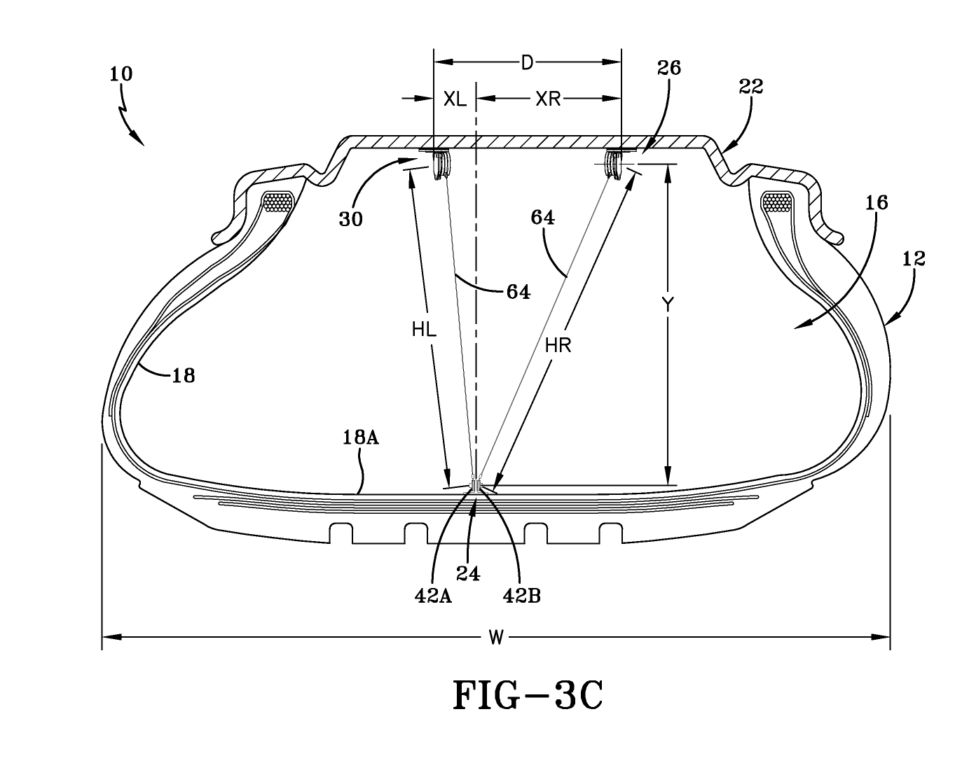

Incorporation of one or more string potentiometers 26, 28, 30, 32 into a tire and rim assembly for the purpose of measuring radial/fore-aft tread displacement and/or radial/lateral displacement will be understood from FIGS. 3A, 3B, and 3C. As shown in FIG. 3A depicting an unloaded tire and rim assembly, a pair of string potentiometers 26, 28 are mounted to the circumferential surface 20 of the rim 22 facing the tire cavity 16. The potentiometers 26, 28 are spaced apart a distance D, representing a constant for the purpose of tire deformation calculation. The anchoring fixture 24 is secured by adhesive attachment or other suitable means to a an attachment point or position on the inner liner 18 opposite the tire crown region 14. The attachment point shown is opposite the crown center of the tread but other locations may be selected if desired. The potentiometers are deployed on the rim surface 20 and the cable 64 from each extended to and connected to the anchoring fixture 24 in the manner shown by FIG. 2A. The location of the anchoring fixture defines the point location that will be analyzed in order to determine the extent of tire crown region deformation within a rolling tire footprint pursuant to the objectives of the invention.

As shown in FIGS. 3A, 3B, and 3C, the length of the cable 64 respectively from potentiometers 26 and 28 to their common attachment to anchoring fixture 24 are identified as HR (right) and HL (left). The radial height of the tire is Y and the width of the tire is W. The assembly is intended to track the position of a point represented by anchoring fixture 24 on the innerliner of the tire at the crown center for a rolling tire. For measurement of lateral displacement of the anchoring point represented at fixture 24, two string potentiometers 26, 28 are attached to the rim. A second set of two string potentiometers are required to monitor the tangential motion of the attachment point 24 on the innerliner as will be explained. FIG. 3B represents the tire and wheel positioned upon a ground surface. Loaded, the radial height Y of the tire will reduce and the tire width W increase as the tire flattens.

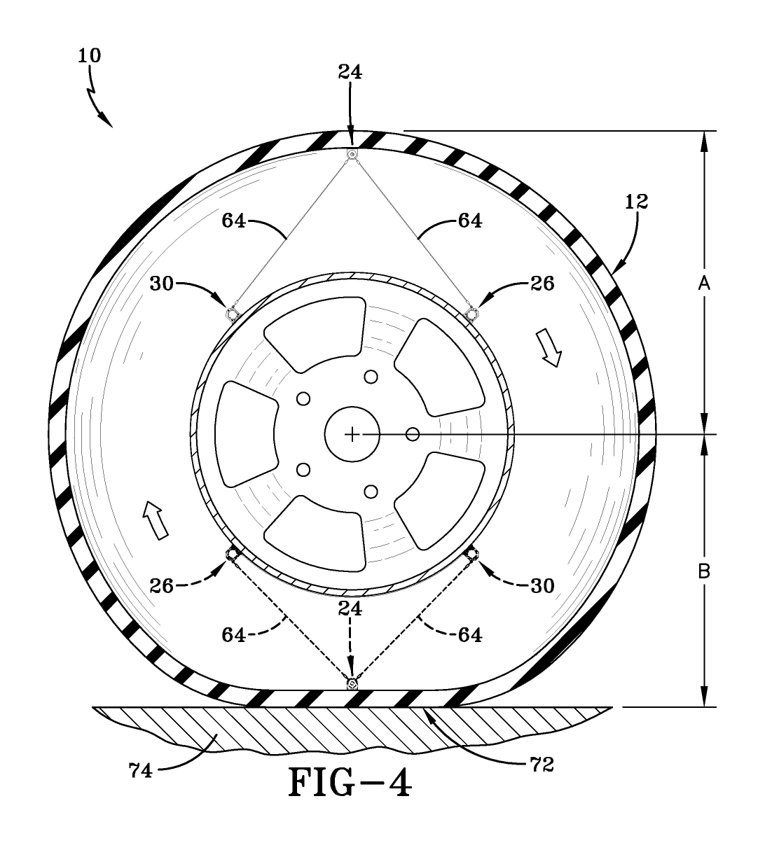

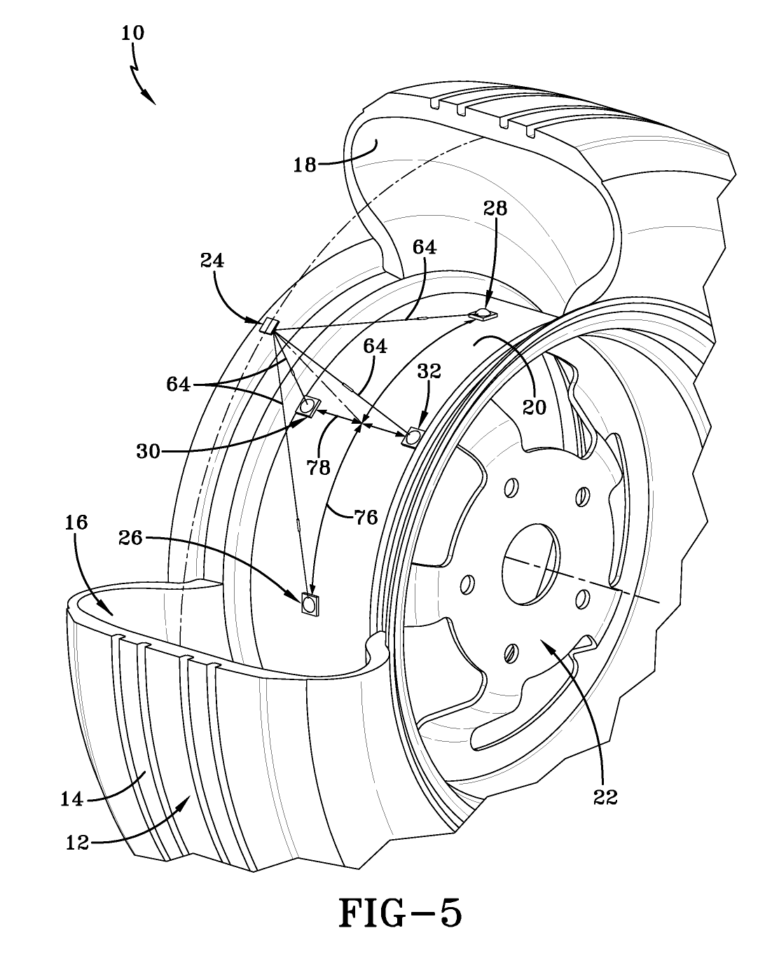

FIGS. 3C and 4 illustrate the tire and rim assembly in a state of rotation against a ground surface 74. The rim to tread height of the tire compresses to an adjusted height B measured from the rim to the tire footprint 72; while the rim to tread dimension A opposite the tire footprint 72 remains unchanged as seen in FIG. 4. When forces are applied to the tire footprint 72 the tire will be displaced and the attachment point represented by the anchoring fixture 24 will change its position relative to the string potentiometers 26, 30 (FIG. 3C). The string potentiometers 26, 30 will measure the lengths of HL and HR through measurement of their respective cables 64 extending to displaced fixture 24. Since the distance D is a known constant, the three unknowns (XL, XR, and Y) can be calculated using the equations below.

XL+XR=D

XL²+Y²=HL²

XR²+Y²=HR²

The attachment point (fixture 24) on the inner liner is displaced due to radial and lateral load on the tire. By monitoring the position of the fixture point on the inner liner at the crown center and knowing the tire stiffness parameters, a real time understanding of the tri-axial reaction forces being applied to the tire footprint by the road surface may be attained. These include not only the radial and lateral forces but also the braking and traction forces. The integration of tracking apparatus within the rim and tire assembly is relatively inexpensive and robust, capable of withstanding the harsh environments an the temperature within a tire cavity during real time operation.

FIG. 5 illustrates an embodiment of the invention in which four potentiometers 26, 28, 30 and 32 are arrayed in quadrants to the rim surface 20. The measuring cable 64 from each of the potentiometers extends to and is coupled to a common anchoring fixture 24 mounted to the tire inner liner 18 at an inner liner crown region opposite to the tread crown region 14 as previously described. For lateral displacements, the two string potentiometers 30, 32 are positioned upon the rim surface 20 along a transverse axis 78. In order to monitor tangential motion of the crown inner liner point of attachment, relative to the rim surface, a second set of string potentiometers 26, 28 are required. The potentiometers 26, 28 are positioned along an axis 76 that extends in a circumferential direction along the rim surface 20. The axis 78 between the first set of potentiometers 30, 32 and the axis 76 between the second set of potentiometers 26,28 are perpendicular, i.e. ninety degrees apart as shown in FIG. 5. The potentiometers 26, 28, 30, 32 are connected to the same attachment point 24.

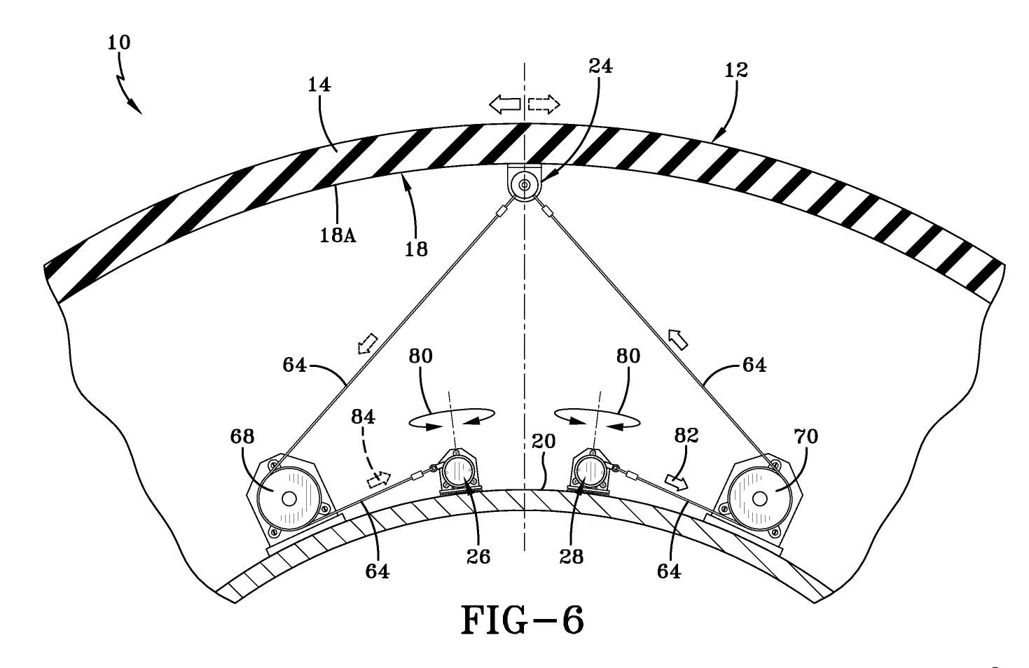

FIG. 6 illustrates an embodiment of the invention in which two potentiometers 26, 28 are mounted in spaced apart relationship to the rim surface 20 as described previously. The potentiometers 26, 28 are pivotally mounted to rotate about a vertical respective axis 80. A pair of idler pulleys 68, 70 are mounted adjacent to respective potentiometers 26, 28 and facilitate the routing of a cable 64 from each potentiometer 28 about a respective idler pulley 70, to the anchoring fixture 24. The idler pulleys 68, 70 thus serve to mechanically route a cable 64 from each of the pair potentiometers 26, 28 along the path illustrated by arrows 82, 84. The advantage of the configuration shown in FIG. 6 is that adding the idler pulleys eliminates side loading on the potentiometer at the cable exit. This will improve the durability of the cable and potentiometer case. With the idler pulleys, the need to mount the potentiometers on a swivel base is eliminated.

From the foregoing, it will be seen that the subject invention provides a cost efficient, robust rim mounted tire and measurement device assembly by which to understand the dynamics of a rolling tire subjected to radial, axial and longitudinal forces and by which to quantify displacement within a rolling tire subject to such forces. The tire, rim, and rim-mounted measurement device assembly integrates at least a pair of string potentiometer measurement devices (26, 28, 30, 32) to a circumferential rim mounting surface 20. Each string potentiometer has an operatively extending and retracting cable 64 component attaching to a common attachment position 24 on the tire inner liner region 18A. Each string potentiometer pair operatively measures a specified type of displacement of the common attachment position responsive to deformation of the tire crown region within a rolling tire footprint.

Two sets of string potentiometer devices 26, 28, and 30, 32 may be mounted to the rim circumferential surface with the cable 64 from each commonly extending to a fixture 24. The first set of string potentiometers operatively measure radial/fore-aft displacement of the respective attachment fixture 24 responsive to deformation of the tire crown region within a rolling tire footprint while the second set of string potentiometers measure tangential motion of the fixture 24. A pair of idler pulleys 68, 70 may be deployed adjacent string potentiometer devices on the rim circumferential surface. Each potentiometer has a separate cable. The respective attachment positions of the first pair of string potentiometers 26, 28, and the second pair of string potentiometers 30, 32 to the tire inner liner region are coincidental.

The embodiment shown in FIG. 4 could have one set of potentiometers for tangential motion and the other set for lateral motion similar to what is shown in FIG. 5. The idea of having both sets measuring tangential motion could possibly add additional insight into the dynamic characteristics of the rolling tire. Additionally, if desired, three potentiometers can be used to define the lateral and tangential motions.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A tire and rim assembly comprising:
a tire mounting rim having a circumferential mounting surface;
a tire mounted over the rim and having an inner liner region radially inward from a crown region of the tire;
at least a first pair of measurement devices mounted to the rim circumferential surface, each measurement device having an operatively extending and retracting component attaching to a respective attachment position on the inner liner region, each of the first pair of measurement devices operatively measuring a displacement of the attachment position responsive to deformation of the tire crown region within a rolling tire footprint.

2. The assembly of claim 1, wherein the first pair of measurement devices comprise a first and a second string potentiometer device mounted in mutually spaced apart mounting locations to the rim circumferential surface to cooperatively measure a displacement of the respective attachment position on the inner liner region responsive to a deformation of the tire crown region within a rolling tire footprint.

3. The assembly of claim 2, wherein further comprising a pair of idler pulleys disposed on the rim circumferential surface, each idler pulley located adjacent to a respective one of the first pair of string potentiometer devices, the extending and retracting component of each string potentiometer comprises a single cable extending between the string potentiometer over a respective idler pulley and to an anchoring fixture position on the inner liner region.

4. The assembly of claim 2, wherein the respective attachment positions of the first pair of string potentiometer devices to the tire inner liner region are substantially coincidental.

5. The assembly of claim 2, wherein further comprising a second pair of measurement devices mounted to the rim circumferential surface, each second pair measurement device having an operatively extending and retracting component attaching to a respective attachment position on the inner liner region, each of the second pair of measurement devices operatively measuring a displacement of the respective attachment position responsive to deformation of the tire crown region within a rolling tire footprint.

6. The assembly of claim 4, wherein the second pair of measurement devices comprise a first and a second string potentiometer device mounted at mutually spaced apart locations on the rim circumferential surface to operatively measure radial and side-to-side displacement of the respective attachment position on the inner liner region responsive to a deformation of the tire crown region within a rolling tire footprint.

7. The assembly of claim 5, wherein the locations of the second pair of string potentiometer devices on the rim mounting surface are positioned along an axis oriented transversely across the rim circumferential surface and substantially ninety degrees with respect to an axis between the first pair of string potentiometers.

8. The assembly of claim 4, wherein each of the first and second pairs of measurement device are positioned along a respective axis mutually oriented substantially ninety degrees with respect to each other.

9. The assembly of claim 8, wherein the respective attachment positions of the measurement devices of the first pair and the second pair of measurement devices to a respective tire inner liner region are substantially coincidental.

10. The assembly of claim 4, wherein the respective attachment positions of the measurement devices of the first pair and the second pair of measurement devices to a respective tire inner liner region are substantially coincidental.

11. A tire and rim assembly comprising:
a tire mounting rim having a circumferential mounting surface;
a tire mounted over the rim and having an inner liner region disposed radially inward from a crown region of the tire;
at least a first pair of measurement devices and a second pair of measurement devices mounted to the rim, each measurement device having an operatively extending and retracting component attaching to the inner liner region at a respective attachment position, each of the measurement devices operatively measuring a displacement of the respective attachment position responsive to deformation of the tire crown region within a rolling tire footprint.

12. The assembly of claim 11, wherein the first pair of measurement devices and the second pair of measurement devices each comprise a first and a second string potentiometer device mounted in mutually spaced apart mounting locations to the rim circumferential surface, the first pair of measurement devices located to operatively measure radial and fore-aft displacement of respective attachment positions on the inner liner region responsive to a deformation of the tire crown region within a rolling tire footprint; and the second pair of measurement devices located to operatively measure radial and side-to-side displacement of respective attachment positions on the inner liner region responsive to a deformation of the tire crown region within a rolling tire footprint.

13. The assembly of claim 12, wherein the first pair of string potentiometer devices and the second pair of string potentiometer devices mounting locations are positioned along a respective axis mutually oriented substantially ninety degrees apart.

14. The assembly of claim 13, wherein the axis of the first pair of string potentiometer devices and the axis of second pair of string potentiometer devices are oriented substantially ninety degrees with respect to each other on the rim circumferential surface.

15. The assembly of claim 14, wherein the respective attachment positions of the first pair of string potentiometer devices to the inner liner region are substantially coincidental with the attachment positions of the second pair of string potentiometer devices.

16. The assembly of claim 11, wherein the respective attachment positions of the first pair of string potentiometer devices to the inner liner region are substantially coincidental with the attachment positions of the second pair of string potentiometer devices.

17. The assembly of claim 11, wherein the length of the extending and retracting component of each string potentiometer within each pair of string potentiometers is an operatively measured value operatively employed in the calculation of a deformation of specified type of the tire crown region within a rolling tire footprint.
